(19) United States
(12) Patent Application Publication
(10) Pub. No.: US 2022/0226736 A1
(43) Pub. Date: Jul. 21, 2022

(54) SELECTION OF VIRTUAL SERVER FOR SMART CLOUD GAMING APPLICATION FROM MULTIPLE CLOUD PROVIDERS BASED ON USER PARAMETERS

(71) Applicant: Ping-Kang Hsiung, El Segundo, CA (US)

(72) Inventor: Ping-Kang Hsiung, El Segundo, CA (US)

(73) Assignee: Ping-Kang Hsiung, El Segundo, CA (US)

(21) Appl. No.: 17/616,505

(22) PCT Filed: Jun. 3, 2020
(86) PCT No.: PCT/US20/35906

§ 371 Date: Dec. 3, 2021

Related U.S. Application Data
(60) Provisional application No. 62/856,161, filed on Jun. 3, 2019.

(51) Int. Cl. A63F 13/77; A63F 13/352; A63F 13/335

(52) U.S. Cl. CPC A63F 13/77; A63F 13/335; A63F 13/352

(57) ABSTRACT

An example method includes identifying one or more available virtual servers configured to provide cloud gaining service to a user device and designating one of the one or more available virtual servers as a connecting virtual server based at least on a comparison between user parameters of the user device and server parameters of the one or more available virtual servers. The example method also includes initiating a connection between the user device and the connecting server for the connecting server to provide cloud gaming services to the user device. The example method also includes transferring the connection between the user device and a connecting server to the user device and a new selected connecting server.

### CROSS-REFERENCE TO RELATED APPLICATIONS

This application claims priority to provisional application No. 62/856,161, filed on Jun. 3, 2019, and titled “Smart cloud gaming application choosing ideal virtual server from multiple cloud providers based on user parameters,” which is hereby incorporated by reference in its entirety.

### BACKGROUND

Cloud gaming generally allows users to play a variety of games on a user device by accessing a virtual machine with cloud gaming software installed. The virtual machine may capture the screen and encode captured images into a continuous video stream to the user device. The user device may then download the video stream, decode the video stream, and upload the user's input actions to the virtual machine. The virtual machine may be implemented at a cloud gaming virtual server. The cloud gaming virtual server may be selected from a single cloud provider from a geographic region near the user, such that the user is assigned to the closest virtual server without input on server parameters such as latency, cost, and server or network performance.

### SUMMARY

Example methods are described herein. An example method includes identifying one or more available virtual servers configured to provide cloud gaming service to a user device and designating one of the one or more available virtual servers as a connecting virtual server based at least on a comparison between user parameters of the user device and server parameters of the one or more available virtual servers. The example method also includes initiating a connection between the user device and the connecting server for the connecting server to provide cloud gaming services to the user device.

In some examples, the server parameters may include one or more of cost, performance, or latency.

In some examples, designating one of the one or more available virtual servers as the connecting virtual server based at least on a comparison between user parameters of the user device and the server parameters of the one or more available virtual servers may include accessing user parameters for the user device and designating one of the one or more available virtual servers as the connecting virtual server when the server parameters of the one of the one or more available virtual servers are closer to the user parameters than the server parameters of the other one or more available virtual servers.

In some examples, the user parameters may be provided by a user of the user device upon configuration of the user device for cloud gaming.

In some examples, the one or more available virtual servers may each correspond to one of a plurality of cloud gaming providers, wherein a user of the user device is registered with the plurality of cloud gaming providers.

In some examples, a method may further include monitoring the server parameters of the one or more available virtual servers while the user device is connected to the connecting server.

In some examples, a method may further include monitoring the user parameters of the user device while the user device is connected to the connecting server.

In some examples, a method may further include determining whether to designation a. different one of the one or more available virtual servers as the connecting server based on an updated comparison of the user parameters and the server parameters, where the determination is made upon detection of a change in the user parameters of the user device or the server parameters of the one or more available virtual servers.

Example computer readable media are described herein. An example non-transitory computer readable media may encode instructions that, when executed by one or more processors of a computing device, cause the computing device to identify one or more available virtual servers configured to provide cloud gaming service to a user device, where the user device is connected to a first virtual server. The instructions may further cause the computing device to designate one of the one or more available virtual servers as the connecting virtual server based at least on a comparison between user parameters of the user device, server parameters of the one or more available virtual servers, and server parameters of the first virtual server. The instructions may also cause the computing device to terminate the connection between the first virtual server and the user device by directing the first virtual server to save a game state and to initiate a connection between the user device and the connecting virtual server by providing the game state to the connecting virtual server.

In some examples, server parameters of the one or more available virtual servers and the server parameters of the first virtual server may include one or more of cost, performance, or latency.

In some examples, the one or more available virtual servers may be identified based on one or more of a location of the user device, one or more connection characteristics of the user device, and registration of the user device with one or more cloud service providers.

In some examples, the instructions may further cause the computing device to transmit payment information for the user device when initiating the connection between the user device and the connecting virtual server.

In some examples, the instructions may further cause the computing device to identify the one or more available virtual servers responsive to a change in one or more of a location of the user device and a connection characteristic of the user device.

In some examples, the instructions may further cause the computing device to monitor the server parameters of the one or more identified available virtual servers and to designate one of the one or more available virtual servers as the connecting server responsive to a change in the server parameters of the one or more identified available virtual servers.

Example computer readable media are described herein. An example non-transitory computer readable media may be encoded with instructions for a cloud gaming application, where the cloud gaming application includes one or more cloud application programming interfaces (APIs), where each of the cloud APIs are configured to connect the cloud gaming application to one or more virtual servers associated with a provider of cloud gaming services. The cloud gaming application may further include a crawler configured to communicate with the one or more cloud APIs to monitor server parameters of the one or more virtual servers accessible through the one or more cloud APIs and a server selector configured to select one of the one or more virtual servers to provide cloud gaming services to a user device associated with the cloud gaming application based at least on a comparison between the server parameters of the one or more virtual servers and user parameters of the user device. The cloud gaming application may further be configured to establish a connection between the selected one of the one or more virtual servers and the cloud gaming application.

In some examples, the server parameters of the one or more virtual servers may include one or more of cost, performance, or latency.

In some examples, the user parameters of the user device may be received from a user of the user device through a user interface of the cloud gaming application.

In some examples, the user device may be registered with each of the providers of cloud gaming services associated with the cloud APIs.

In some examples, the crawler may be further configured to monitor the server parameters of the one or more virtual servers accessible through one or more cloud APIs after the connection is established between the selected one of the one or more virtual servers and the cloud gaming application.

In some examples, the cloud gaming application may be further configured to establish the connection between the selected one of the one or more virtual servers and the cloud gaming application by initiating creation of a user virtual machine at the selected one of the one or more virtual servers.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a schematic illustration of an environment 100 in accordance with examples described herein.

FIG. 2 is a schematic illustration of an environment 200 in accordance with examples described herein.

FIG. 3 illustrates a method 300 in accordance with examples described herein.

FIG. 4 illustrates a method 400 in accordance with examples described herein.

FIG. 5 illustrates a computing system 500 in accordance with examples described herein.

### DETAILED DESCRIPTION

Cloud gaming allows users with many types of user devices to take advantage of advanced graphics and processing capability of remote servers by connecting to a remote server. Cloud service providers, or providers of cloud gaming services, may use multiple servers in multiple data centers to provide cloud gaming services to end users. Generally, when a user accesses a cloud gaming service, the user is automatically connected to the remote servers that are geographically closest to the user and associated with the cloud service provider. In some cases, the user's gaming experience may be improved by connecting to a server other than the server that is geographically closest. For example, other virtual servers may be reasonably geographically close (e.g., can serve the user device without prohibitive latency) and have better graphics capabilities than the virtual server that is geographically closest to the user.

Further, because cloud gaming applications may be executed on a variety of user devices, including mobile devices (e.g., smartphones or tablets), different virtual servers may become available to a user device during game play. Accordingly, it may improve the user's gaming experience to connect to a different virtual server during game play.

Examples of cloud gaming applications described herein generally execute on a user device and identify one or more available virtual servers configured and able to provide cloud gaming services to the user device. The cloud gaming applications may designate one of the one or more available virtual servers as a connecting virtual server (e.g., the virtual server that the user device will connect to for cloud gaming services) based at least on a comparison between user parameters of the user device and server parameters of the one or more available virtual servers. Cloud gaming applications may also initiate a connection between the user device and the connecting server for the connecting server to provide cloud gaming services to the user device.

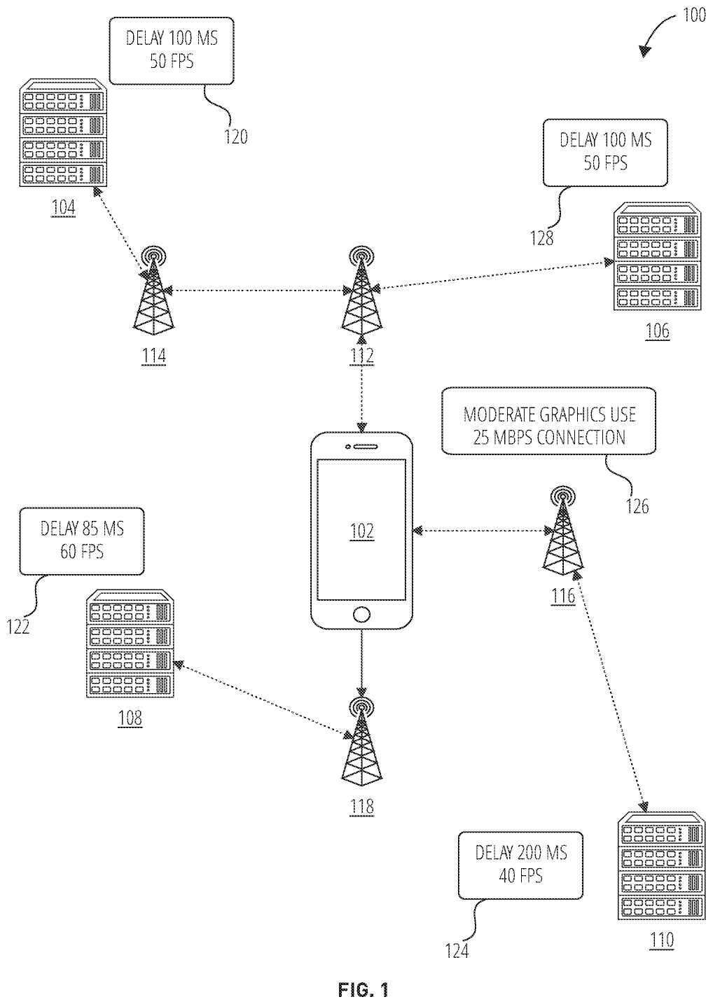

FIG. 1 illustrates an example use of a cloud gaming application executing on a user device 102 to connect the user device 102 to a virtual server. In the environment 100 of FIG. 1, the user device 102 is in a geographic location where it is able to connect to any of the virtual servers 104, 106, 108, or 110 through connection points 112, 114, 116, or 118. The user device 102 may be utilizing a connection with a speed of 25 Mbps and making moderate use of graphics resources. The cloud gaming application may assess server parameters associated with the virtual servers 104, 106, 108, and 110 to determine which of the virtual servers 104, 106, 108, and 110 will best serve the needs of the user device 102, as expressed in user parameters 126.

Examples described herein may include a user device and/or may be utilized with a user device, such as the user device 102. The user device 102 may be implemented using any number of computing devices including, but not limited to, a computer, a laptop, tablet, mobile phone, gaming console, smart phone, smart speaker, smart television, vehicle (e.g., automobile), or any other device utilizing a network connection. Generally, the user device 102 may include one or more processors, such as a central processing unit (CPU) and/or graphics processing unit (GPU). The user device 102 may generally perform operations by executing executable instructions (e.g., software) using the processor(s). As described herein, in some examples, the user device 102 may communicate with one or more virtual servers to obtain cloud gaming services on the user device 102. In some implementations, the user device 102 may include multiple pieces of hardware that may communicate through a wired or wireless connection. For example, in some implementations, the user device 102 may be implemented by a television and a gaming controller connected to the television via Bluetooth or WiFi.

The user device 102 may be associated with user parameters 126. User parameters 126 may include a variety of information about the user device 102, the preferences of the user, requirements of the game being played by the user, information about the type of connection of the user device 102 (e.g., 5G or WiFi), or any other information relevant to determining which virtual server may best serve the user and the user device 102. Accordingly, some user parameters 126 may be determined based on characteristics of the user device 102 and the connections available to the user device 102, while other user parameters 126 may be provided by the user when configuring the user device 102 for cloud gaming.

Some examples of user parameters 126 associated with the user device 102 may include, but are not limited to, geographic location of the user device 102, type of network connections (e.g., 5G or WiFi) available to the user device 102, download and upload speeds of the network utilized by the user device 102, bandwidth of the network utilized by the user device 102, compression format and bit-rate, and display characteristics (e.g., size or resolution) of any display associated with the user device 102. Some examples of user parameters 126 associated with the user or use of the user device 102 may include, but are not limited to, cloud service providers with which the user has a registered account, price preferences, performance preferences, graphics preferences, speed preferences, and type of game played (e.g., first person shooter, live action role play, or real time strategy). User parameters 126 directed to preferences may be expressed in numerous different ways. For example, in one implementation, price, performance, graphics, and speed may be ranked by most to least important. In addition or in the alternative, limits, such as upper price limits or minimum speed limits may be chosen. For example, user parameters may include minimal acceptable quality, minimum acceptable resolution, or desired display aspect ratio. In some implementations, user rankings or limits may be augmented by requirements of the specific game being played. For example, the user may indicate that speed is the lowest priority. However, when the user plays a first person shooter game requiring less than 100 ms in delay or latency, the speed preference may be augmented to have a maximum latency of 100 ms. Some user parameters may also be game-playing settings, which may be game specific or applicable across games. For example, preferred graphics quality, operating system required, response time, display modes, display resolution, filters, and audio preferences may be game-playing settings. For multiplayer games, game-playing settings or parameters may also include average latency among all players or preferred latency optimized for one or several of the players.

Examples described herein may include virtual servers, such as virtual servers 104, 106, 108, and 110 in FIG. 1. The virtual server 104 may be part of a larger data center. Generally, the virtual server 104 has access to resources for communications, processing, graphics processing, and memory, where the resources are located within the data center. For example, a virtual server 104 may be allocated to a number of CPUs, GPUs, ROM and RAM. The virtual server 104 may, in some implementations be implemented at a node of a datacenter by a hypervisor, where the hypervisor coordinates use of the various computing and graphics resources available to the virtual server 104. The various components and resources available to the virtual server 104 may communicate with the hypervisor using any type of connection such as a wide area network (WAN), local area network (LAN), or wireless connections.

In some implementations, virtual servers may include servers using computing resources outside of traditional data centers. For example, a virtual server may use local resources (e.g., a server on premises that the user device 102 may or may not already be connected to, either in a wired or wireless network) or private computing resources loaned or rented out to the public on an ad-hoc basis.

To provide cloud gaming services to the user device 102, the virtual server 104 receives input from the user device 102 and processes the input to update a game state using game logic and processing resources. The virtual server 104 then renders graphics consistent with the updated game state using graphics resources available to the virtual server 104 and encodes the updated graphics for transmission to the user device 102 before transmitting the encoded graphics to the user device 102. The virtual server 106, the virtual server 108, and the virtual server 110 may be implemented using similar components and systems as those described above with respect to the virtual server 104. In some implementations, the virtual server 104 further allocates a defined amount of its resources to a user, by partitioning the virtual server 104 into several user virtual machines (VMs) which may be created or assigned to users upon connection to the virtual server 104.

The virtual servers 104, 106, 108, and 110 may be associated with server parameters. For example, the virtual server 104 is associated with server parameters 120, showing that the virtual server 104 has a rendering rate of 50 frames per second and a processing delay of 100 ms. Other possible server parameters may include, but are not limited to, latency relative to the user device 102, memory available to a user of the virtual server 104, number and type of computing resources (e.g., CPUs or GPUs) available to a user of the virtual server 104, cost to connect to the virtual server 104, memory allocated to a user of the virtual server 104, games available for play through the virtual server 104, and bandwidth transmitted by the virtual server 104. The server parameters 128 associated with virtual server 106, the server parameters 124 associated with virtual server 110, and the server parameters 122 associated with virtual server 108 may include similar measures and statistics relating to the virtual server 106, virtual server 110, and virtual server 108, respectively. Server parameters may also be based on historical statistics. In some implementations, the historical statistics may be framed in a certain geographic area or in a certain time frame. For example, a server parameter may measure average network performance on a Wednesday between 10-11 a.m. in a particular area of California.

A cloud gaming application may compare the user parameters 126 to the server parameters 120, 122, 124, and 128 associated with the virtual servers 104, 106, 108, and 110. After determining which of the virtual servers 104, 106, 108, and 110 to connect with, the cloud gaming application may configure the connection between the user device 102 and the chosen virtual server so that the virtual server provides cloud gaming service to the user device 102.

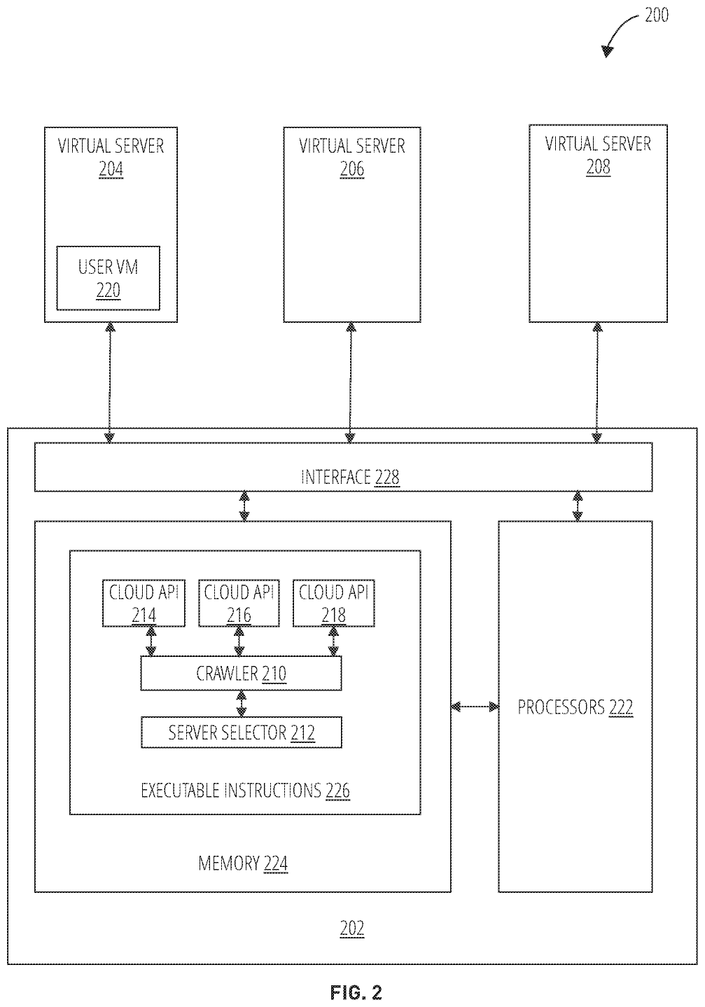

FIG. 2 illustrates an example cloud gaming application implemented by executable instructions 226 executing on processors 222 of a user device 202. The executable instructions 226 include instructions for implementing a server selector 212, a crawler 210, and cloud APIs 214, 216, and 218, which together form executable instructions 226 for the cloud gaming application. The memory 224 and the processors 222 of the user device 202 communicate such that the processors 222 may access the executable instructions 226 on the memory 224 to execute the cloud gaming application on the user device 202. The processors 222 and the memory 224 also communicate with an interface 228 of the user device 202 so that the user device 202 may connect to virtual servers 202, 204, and 206 so that the virtual servers 202, 204, and 206 may provide cloud gaming service to the user device 202 and the cloud gaming application may monitor server parameters of the virtual servers 202, 204, and 206.

The user device 202 may be implemented using the same or different types of hardware as described with respect to user device 202. The user device 202 includes memory 224 and one or more processors 222. The memory 224 may store executable instructions 226 to be executed by the processors 222 to implement various applications on the user device 202. The executable instructions 226 shown in FIG. 2 include executable instructions for various components of a cloud gaming application. The memory 224 of the user device 202 may include multiple memory elements of varying types. For example, the memory 224 may include both volatile and non-volatile components, such as, for example, magneto-optical storage, read-only memory, random access memory, erasable programmable memory, flash memory, or a combination of one or more types of memory components. The memory 224 may also include memory components accessible to the user device 202 such as external hard drives, flash drives, cloud storage, or other types of remote memory.

The processors 222 of the user device 202 may be implemented by one or more types of processing components. For example, the processors 222 may be implemented by a central processing unit, microprocessor, processor, microcontroller, or programmable logic components (e.g., FPGAs). Additionally, the processors 222 may include additional processing resources accessible by the user device 202, such as remote processors.

The interface 228 may provide for communication between the user device 202 and other networked devices, such as the virtual servers 202, 204, and 206. In various embodiments, the interface 228 may provide connectivity to networks including the Internet, a local area network (LAN), a wide area network (WAN), or other network. In addition to traditional data-networking protocols, in some embodiments, the interface 228 may provide for communication according to protocols and/or standards including near field communication (NFC), Bluetooth, cellular networks, and the like. The interface 228 may provide either wired or wireless connections to the user device 202.

Generally, the executable instructions 226 for the cloud gaming application may be implemented as part of an application where the user device 202 interacts with a remote server to obtain cloud gaming services. In such implementations, the executable instructions 226 may further include instructions for decoding graphics streams received from a remote server, receiving user input and sending user input to the remote server, and other executable instructions for implementing cloud gaming on the user device 202. In other implementations the cloud gaming application may be a separate application executing on the user device 202, separate from an application used for implementing cloud gaming on the user device 202 and interacting with a remote server once the user device 202 is connected to the remote server. In these implementations, the executable instructions 226 may include instructions for interfacing with other applications executing on the user device 202.

The virtual servers 204, 206, and 208 may be implemented by the same or different combinations of hardware and software as described with respect to the virtual servers 104, 106, 108, and 110. The virtual server 204 is connected to provide cloud gaming services to the user device 202. A user virtual machine (VM) 220 is located at the virtual server 204. The user VM 220 generally serves the user device 202. Generally, the user VM 220 may include a specific amount of allocated resources (e.g., memory, graphics, and processing resources) of the virtual server 204 allocated to the user device 202. The user VM 220 may be implemented using a hypervisor to communicate with the allocated resources and the user device 202.

The user device 202 shown in FIG. 2 is also in communication with virtual servers 206 and 208 through the cloud APIs corresponding to the virtual servers 206 and 208. The user device 202 may communicate with the virtual servers 206 and 208 to monitor server parameters of the virtual servers 206 and 208. In some examples, the crawler 210 of the cloud gaming application may monitor the server parameters of the virtual servers 206 and 208 and, upon detecting a change in the server parameters, may re-evaluate which virtual server of the virtual servers 204, 206, and 208 should provide cloud gaming services to the user device 202. Additionally, the crawler 210 may monitor user parameters and, upon detecting a change in the user parameters, may re-evaluate which virtual server of the virtual servers 204, 206, and 208 should provide cloud gaming services to the user device 202.

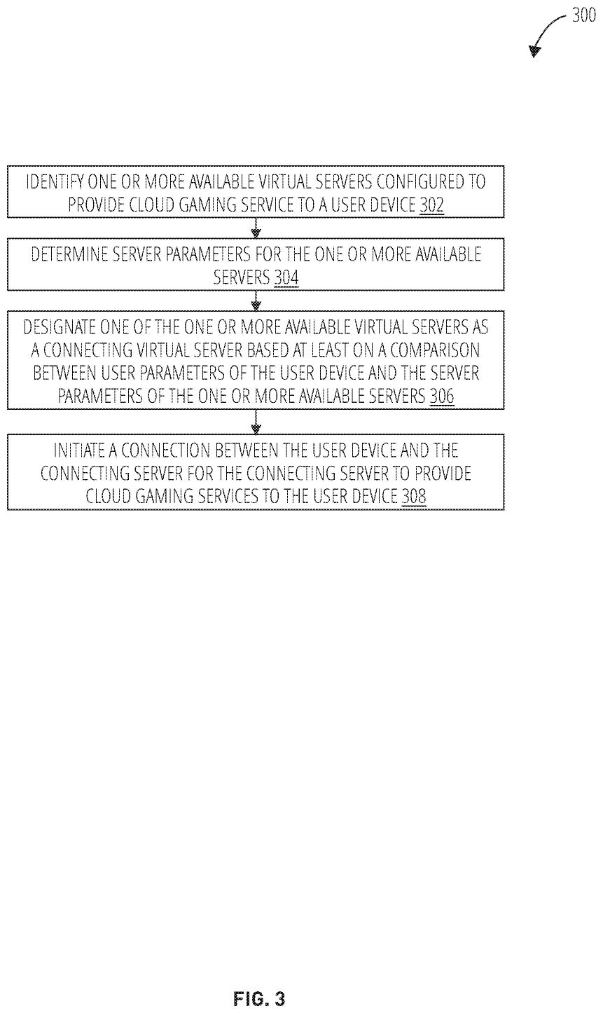

FIG. 3 illustrates a method 300 using a cloud gaming application to choose a virtual server to provide cloud gaming services to a user device (e.g., user device 102 or user device 102) executing the cloud gaming application. The description below focuses on the method 300 in the environment 200, though it should be understood that the method 300 may be executed in other environments, such as the environment 100 of FIG. 1.

In some implementations, prior to execution of the method 300, the user device 202 may be configured to connect with cloud gaming services. For example, a user of the user device 202 may enter a corresponding password, payment information, or other login type information to log in to accounts associated with various cloud gaming services. In other implementations, the user may register for various cloud gaming services using the user device 202.

A operation 302 identifies one or more available virtual servers configured to provide cloud gaming service to the user device 202. In some examples, available virtual servers may be identified based on the location of the user device 202. For example, the user device 202 may attempt to connect to any virtual servers providing cloud gaming services within a particular geographic region (e.g., within 250 miles). In addition or alternatively, the operation 302 may identify virtual servers that are associated with cloud gaming services with which the user device 202 is already registered. The identification of available virtual servers may be further limited by connection type of the user device 202, current utilization of virtual servers within a specified geographic region, and other relevant features of either the user device 202 or virtual servers.

In some implementations, the user of the user device 202 may provide additional input to identify available virtual servers. For example, the user may provide a particular game and the identification of available virtual servers may be narrowed based on which game is desired by the user. For example, some servers within a particular geographic region may not provide cloud streaming for a particular game and would therefore not be identified as available virtual servers. In other examples, the game identified by the user may have a particularly low delay threshold (e.g., a first person shooter game) where the geographic radius may be narrowed to accommodate the lower delay threshold. Further, in some implementations, the user may identify a particular cloud service provider, such that the operation 302 would identify only virtual servers associated with the identified cloud service provider. The user may identify the cloud service provider directly through a user interface of the cloud gaming application or indirectly by, for example, launching a gaming application associated with a particular cloud service provider.

A operation 304 determines server parameters for the one or more available virtual servers. In some implementations, the operation 304 may include obtaining and configuring cloud APIs for the identified available virtual servers. The cloud APIs may then be used by the cloud gaming application to communicate with the available virtual servers, including to determine at least some of the server parameters for the available virtual servers. For example, the executable instructions 226 for the cloud gaming application on the virtual server 208 include cloud API 214, cloud API 216, and cloud API 218 configured to communicate with the crawler 210 such that the crawler 210 may collect data, such as server parameters about the virtual server 204, the virtual server 206, and the virtual server 208.

In some implementations, some server parameters, such as graphics resources, cost, available games, processing delay, server bandwidth, and connection speed parameters may be obtained by the crawler 210 directly through the cloud APIs. In some implementations, the crawler 210 may also connect to a network through the interface 228 to search for server parameters for available virtual servers without available cloud APIs or to search for additional server parameters for the virtual servers 204, 206, and 208. In some implementations, some server parameters may also be determined at the user device 202 by testing the connection between the user device 202 and a virtual server. For example, the executable instructions 226 may include instructions to calculate latency or to send a data packet to a virtual server to determine round trip time of the data packet. The operation 304 may include storing server parameters for later use by the cloud gaming application or by other applications executing on the user device 202.

A operation 306 designates one of the one or more available virtual servers as a connecting virtual server based at least on a comparison between user parameters of the user device 202 and the server parameters of the one or more available virtual servers. The cloud gaming application may determine or collect user parameters corresponding to the user device 202 through multiple methods. For example, in some implementations, user parameters may be collected by the cloud gaming application through a user interface of the cloud gaming application. The user interface may allow the user to provide exact numbers for user parameters (e.g., to provide a value for a delay threshold that the user is willing to tolerate) and/or to rank user parameters from a list presented to the user. For example, the user interface may present the user with a list of broad categories of user parameters including cost, latency, and performance, and instruct the user to rank the presented parameters based on their relative importance to the user. The user interface may, either additionally or alternatively, ask the user to assign a numerical value to each of the broad categories of user parameters. For example, the user may be asked to rate the importance of each of cost, latency, and performance on a scale of 1-10.

User parameters may also be determined based on a user's history of using the connecting virtual server or based on the particular game or type of game usually or currently being played by the user. For example, a user who generally plays real time strategy games and has never or rarely used the cloud gaming application in conjunction with streaming a first person shooter game may be assigned a higher delay threshold than a player who has exclusively used the cloud gaming application in conjunction with streaming first person shooter games. Similarly, user parameters may be determined and adjusted based on a game either input by the user or being currently played by the user. In these implementations, particular games may be associated with particular user parameters (e.g., graphics requirements. processing requirements, etc.). Games may also be associated with a game type (e.g., first person shooter, role playing game, or real time strategy game) associated with particular user parameters.

The comparison between the user parameters and the server parameters determined in operation 304 may be implemented using multiple techniques. To execute the comparison, the cloud gaming application may match user parameters with corresponding server parameters. For example, a server parameter for network speed requirement may be matched with a user parameter for the user's upload and download speeds.

In some examples, some user parameters may be used to eliminate some servers entirely from consideration after matching the user parameters and server parameters. For example, a user parameter may specify particular graphics resources for a particular game. Servers with server parameters indicating that the virtual servers do not have access to those particular graphics resources may be eliminated from consideration. For the remaining servers, in some implementations, scores may be calculated for each virtual server in each broad category presented to the user based on the server parameters. The virtual server with the highest scores in the category indicated as most important by the user may then be designated as the connecting server. Similarly, other user parameters such as a user's operating system or desired server architecture may also be used to eliminate servers from consideration.

A operation 308 initiates a connection between the user device 102 and the connecting server to provide cloud gaming services to the user device 102. The operation 308 may include sending a request to the connecting server to create a user VM with a particular amount of allocated resources at the connecting server. For example, the virtual server 204 includes a user VM 220 to coordinate resources to provide cloud gaming to the user device 202.

In some implementations, a method 400 may monitor and evaluate available virtual servers and corresponding server parameters while the user device 202 is being used for cloud gaming through a connection with the connecting server (e.g., the virtual server 204). The method 400 may also monitor and evaluate user parameters relating to the user device 202.

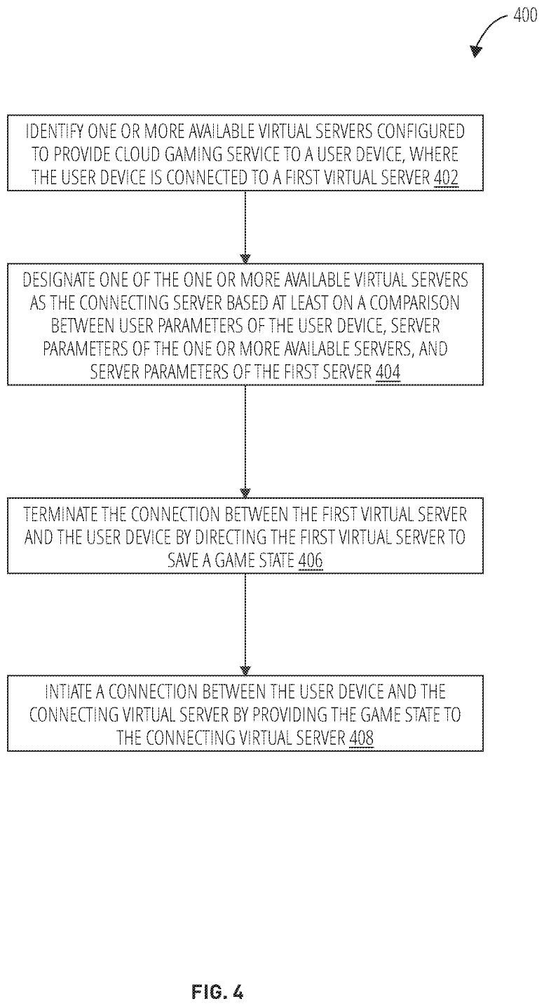

FIG. 4 illustrates a method 400 using a cloud gaming application to choose a virtual server to provide cloud gaming services to a user device (e.g., user device 102 or user device 102) executing the cloud gaming application. The description below focuses on the method 400 in the environment 200, though it should be understood that the method 400 may he executed in other environments, such as the environment 100 of FIG. 1.

A operation 402 identifies one or more available virtual servers configured to provide cloud gaming service to a user device 202, where the user device 202 is connected to a virtual server 204. In some implementations, the operation 402 may be triggered by a change in user parameters. For example, where the user device 202 is a mobile device, the location of the user device 202 may change and new virtual servers may become available. Similarly, the user device 202 may switch from streaming one game to another game, changing the user parameters. Other user parameters, In other implementations, the operation 402 may occur at specified or preset time intervals as the user device 202 is in use for cloud gaming streaming. Additionally or alternatively, the operation 402 may be triggered by changes in parameters of servers being actively monitored by a crawler 210 of the user device 2020. The operation 402 may use similar methods and implementations as described above with respect to operation 302. Accordingly, the operation 402 may utilize an interface 228 to identify available virtual servers.

A operation 404 designates one of the one or more available virtual servers as the connecting server based at least on a comparison between user parameters of the user device 102, server parameters of the one or more available virtual servers, and server parameters of the virtual server 104. The operation 404 may use similar methods and implementations as described above with respect to the operation 306. In addition, the operation 404 may use additional factors when designating a connecting server. For example, in some implementations, a user parameters may include a preference for staying connected to the first virtual server (virtual server 204 in FIG. 2) rather than connecting to new servers as long as the virtual server 204 is performing above a certain threshold. Further, the operation 404 may consider changes in user parameters, such as location changes when designating a new connecting server. For example, where the location of the user device 202 is changing, new virtual servers may become available. However, where the user device 202 is moving in a particular direction, some available virtual servers may become unavailable more quickly as the user device 202 continues moving. Accordingly, preference may be given to available virtual servers likely to be in range of the user device 202 for longer, based on the historical movement of the user device 202.

In multiplayer games, the operation 404 may take into account user parameters for each of the players engaged in the game. Optimizations or calculations performed during the operation 404 may also include “migration cost” including the migration of a saved game from the current virtual server to the new virtual server and the starting up cost of the game on the new virtual server. Alternatively, the transfer may be pre-scheduled based on time or location.

A operation 406 terminates the connection between the virtual server 204 and the user device 202 by directing the virtual server 204 to save a game state. In some implementations, the operation 406 may include a prompt to the user via a display of the user device 202 asking the user to consent to the termination and switching virtual servers. The saved game state generally includes the current graphics renderings, commands, location of various game elements within the larger game universe, user score, and other important metrics. Accordingly, the game state essentially pauses the game, allowing the game state to be loaded at another server and the game resumed with minimal data loss and user disruption. In some implementations, the game state may be transmitted to the user device 202 or saved to a particular remote storage location.

A operation 408 initiates a connection between the user device 202 and the connecting virtual server by providing the game state to the connecting virtual server. The operation 408 may include any or all of the methods described in the operation 308. For example, the operation 408 may request creation of a user VM at the connecting virtual server. The cloud gaming services may then be resumed when the game state is loaded at the connecting virtual server. In some implementations, the virtual server 204 may send the game state directly to the connecting virtual server at the request of the user device 202. In other implementations, the operation 408 may include directing the connecting virtual server to retrieve the game state from remote storage location.

When the operation 408 is complete and the connecting virtual server is actively providing cloud gaming services to the user device 202, the method 400 may repeat to evaluate available virtual servers as the user continues game play.

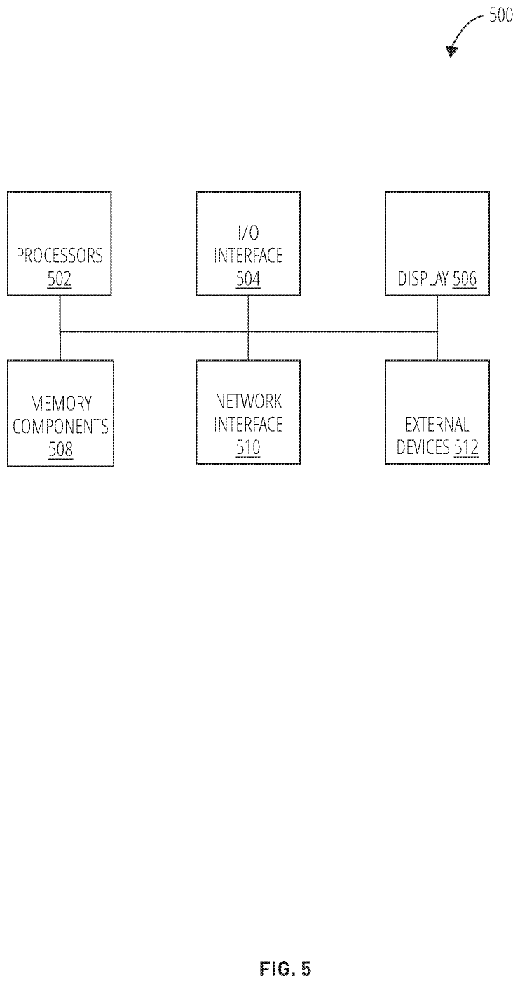

FIG. 5 is a schematic diagram of an example computing system 500 for implementing various embodiments in the examples described herein. A computing system 500 may be used to implement the user device 102 or integrated into one or more components of the system. The computing system 500 may be used to implement or execute one or more of the components or operations disclosed in FIGS. 1-4. In FIG. 5, the computing system 500 may include one or more processors 502, an input/output (I/O) interface 504, a display 506, one or more memory components 508, a network interface 510, and one or more external devices 512. Each of the various components may be in communication with one another through one or more buses or communication networks, such as wired or wireless networks.

The processors 502 may be implemented using generally any type of electronic device capable of processing, receiving, and/or transmitting instructions. For example, the processors 502 may include or be implemented by a central processing unit, microprocessor, processor, microcontroller, or programmable logic components (e.g., FPGAs). Additionally, it should be noted that some components of the computing system 500 may be controlled by a first processor and other components may be controlled by a second processor, where the first and second processors may or may not be in communication with each other.

The memory components 508 are used by the computing system 500 to store instructions, such as executable instructions 226, for the processors 502, as well as to store data, such as reference data and the like. The memory components 508 may be, for example, magneto-optical storage, read-only memory, random access memory, erasable programmable memory, flash memory, or a combination of one or more types of memory components.

The display 506 provides visual feedback to a user, such as user interface elements of a cloud gaming application. Optionally, the display 506 may act as an input element to enable a. user to control, manipulate, and calibrate various components of the system as described in the present disclosure. The display 506 may be a liquid crystal display, plasma display, organic light-emitting diode display, and/or other suitable display. In embodiments where the display 506 is used as an input, the display 506 may include one or more touch or input sensors, such as capacitive touch sensors, a resistive grid, or the like.

The I/O interface 504 allows a user to enter data into the computing system 500, as well as provides an input/output for the computing system 500 to communicate with other devices or services, such as virtual server 104, virtual server 206, and virtual server 208 in FIG. 2. The I/O interface 504 can include one or more input buttons, touch pads, track pads, and so on.

The network interface 510 provides communication to and from the computing system 500 to other devices. For example, the network interface 510 may allow the user device 102 to communicate with virtual server 104 through a communication network. The network interface 510 includes one or more communication protocols, such as, but not limited to WiFi, Ethernet, Bluetooth, Cellular data networks, and so on. The network interface 510 may also include one or more hardwired components, such as a Universal Serial Bus (USB) cable, or the like. The configuration of the network interface 510 depends on the types of communication desired and may be modified to communicate via WiFi, Bluetooth, and so on.

The external devices 512 may include one or more device that can be used to provide various inputs to the computing system 500, e.g., mouse, microphone, keyboard, trackpad, or the like. The external devices 512 may be local or remote and may vary as desired. In some examples, the external devices 512 may also include one or more additional sensors.

The foregoing description has a broad application. For example, while examples disclosed herein may focus on a central communication system, it should be appreciated that the concepts disclosed herein may equally apply to other systems, such as a distributed, central or decentralized system, or a cloud system. One or more components of systems described herein may also reside in a controller virtual machine (VM) or a hypervisor in a VM computing environment. Accordingly, the disclosure is meant only to provide examples of various systems and method and is not intended to suggest that the scope of the disclosure, including the claims, is limited to these examples.

The technology described herein may be implemented as logical operations and/or modules in one or more systems. The logical operations may be implemented as a sequence of processor-implemented steps directed by software programs executing in one or more computer systems and as interconnected machine or circuit models within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operation making up the embodiments of the technology described herein are referred to variously as operations, steps, objects, or modules. Furthermore, it should be understood that logical operations may be performed in any order unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. it should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method comprising:
identifying one or more available virtual servers configured to provide cloud gaming service to a user device;
designating one of the one or more available virtual servers as a connecting virtual server based at least on a comparison between user parameters of the user device and server parameters of the one or more available virtual servers; and
initiating a connection between the user device and the connecting server for the connecting server to provide cloud gaming services to the user device.

2. The method of claim 1, wherein the server parameters include one or more of operating system installed, cost, specification and performance of the server, performance of the network, or latency.

3. The method of claim 1, wherein designating one of the one or more available virtual servers as the connecting virtual server based at least on a comparison between user parameters of the user device and the server parameters of the one or more available virtual servers comprises:
accessing user parameters for the user device; and
designating one of the one or more available virtual servers as the connecting virtual server when the server parameters of the one of the one or more available virtual servers are closer to the user parameters than the server parameters of the other one or more available virtual servers.

4. The method of claim 3, wherein the user parameters are provided by a user of the user device upon configuration of the user device for cloud gaming.

5. The method of claim 1, wherein the one or more available virtual servers each correspond to one of a plurality of cloud gaming providers, wherein a user of the user device is registered with the plurality of cloud gaming providers.

6. The method of claim 1, further comprising:
while the user device is connected to the connecting server, monitoring the server parameters of the one or more available virtual servers.

7. The method of claim 6, further comprising:
while the user device is connected to the connecting server, monitoring the user parameters of the user device.

8. The method of claim 7, further comprising:
upon detection of a change in the user parameters of the user device or the server parameters of the one or more available virtual servers, determining whether to designate a different one of the one or more available virtual servers as the connecting server based on an updated comparison of the user parameters and the server parameters.

9. One or more non-transitory computer readable media encoding instructions that, when executed by one or more processors of a computing device, cause the computing device to:
identify one or more available virtual servers configured to provide cloud gaming service to a user device, wherein the user device is connected to a first virtual server;
designate one of the one or more available virtual servers as the connecting virtual server based at least on a comparison between user parameters of the user device, server parameters of the one or more available virtual servers, and server parameters of the first virtual server;
terminate the connection between the first virtual server and the user device by directing the first virtual server to save a game state;
initiate a connection between the user device and the connecting virtual server by providing the game state to the connecting virtual server.

10. The one or more non-transitory computer readable media of claim 9, wherein the server parameters of the one or more available virtual servers and the server parameters of the first virtual server include one or more of operating system installed, cost, performance of the server, performance of the network, or latency.

11. The one or more non-transitory computer readable media of claim 9, wherein the one or more available virtual servers are identified based on one or more of a location of the user device, one or more connection characteristics of the user device, and registration of the user device with one or more cloud service providers.

12. The one or more non-transitory computer readable media of claim 9, wherein the instructions further cause the computing device to transmit payment information for the user device when initiating the connection between the user device and the connecting virtual server.

13. The one or more non-transitory computer readable media of claim 9, wherein the instructions further cause the computing device to identify the one or more available virtual servers responsive to a change in one or more of a location of the user device and a connection characteristic of the user device.

14. The one or more non-transitory computer readable media of claim 9, wherein the instructions further cause the computing device to monitor the server parameters of the one or more identified available virtual servers and to designate one of the one of more available virtual servers as the connecting server responsive to a change in the server parameters of the one or more identified available virtual servers.

15. At least one non-transitory computer readable media encoded with instructions for a cloud gaming application, wherein the cloud gaming application includes:
one or more cloud application programming interfaces (APIs), each of the cloud APIs configured to connect the cloud gaming application to one or more virtual servers associated with a provider of cloud gaming services;
a crawler configured to communicate with the one or more cloud APIs to monitor server parameters of the one or more virtual servers accessible through the one or more cloud APIs; and
a server selector configured to select one of the one or more virtual servers to provide cloud gaming services to a user device associated with the cloud gaming application based at least on a comparison between the server parameters of the one or more virtual servers and user parameters of the user device,
wherein the cloud gaming application is configured to establish a connection between the selected one of the one or more virtual servers and the cloud gaming application.

16. The at least one non-transitory computer readable media of claim 15, wherein the server parameters of the one or more virtual servers include one or more of operating system installed, cost, performance of the server, performance of the network, or latency.

17. The at least one non-transitory computer readable media of claim 15, wherein the user parameters of the user device are received from a user of the user device through a user interface of the cloud gaming application.

18. The at least one non-transitory computer readable media of claim 15, wherein the user device is registered with each of the providers of cloud gaming services associated with the cloud APIs.

19. The at least one non-transitory computer readable media of claim 15, wherein the crawler is further configured to monitor the server parameters of the one or more virtual servers accessible through the one or more cloud APIs after the connection is established between the selected one of the one or more virtual servers and the cloud gaming application.

20. The at least one non-transitory computer readable media of claim 15, wherein the cloud gaming application is configured to establish the connection between the selected one of the one or more virtual servers and the cloud gaming application by initiating creation of a user virtual machine at the selected one of the one or more virtual servers.
